(19) United States
(12) Patent Application Publication
(10) Pub. No.: US 2016/0065466 A1
(43) Pub. Date: Mar. 3, 2016

(54) SYSTEMS AND METHODS FOR SIGNALING MULTI-DESTINATION AGGREGATED MULTI-USER MEDIA ACCESS CONTROL PROTOCOL DATA UNITS IN A WIRELESS NETWORK

(71) Applicant: QUALCOMM Incorporated, San Diego, CA (US)

(72) Inventors: Santosh Paul Abraham, San Diego, CA (US); Simone Merlin, San Diego, CA (US); George Cherian, San Diego, CA (US); Gwendolyn Denise Barriac, Encinitas, CA (US); Sameer Vermani, San Diego, CA (US)

(21) Appl. No.: 14/836,899

(22) Filed: Aug. 26, 2015

Related U.S. Application Data
(60) Provisional application No. 62/043,061, filed on Aug. 28, 2014.

(51) Int. Cl. H04L 12/741; H04L 29/12; H04L 29/06

(52) U.S. Cl. CPC H04L 45/74; H04L 69/22; H04L 61/6022

(57) ABSTRACT

Systems, methods, and apparatuses for aggregating multi-user media access control protocol data units (MPDU) in a wireless network are provided. One aspect of this disclosure provides a method of wireless communication. The method includes generating, by an apparatus, an aggregated media access control protocol data unit (A-MPDU) frame comprising a plurality of A-MPDU sub-frames, wherein at least one sub-frame of the plurality of A-MPDU sub-frames is addressed to at least a first device and at least one other sub-frame of the plurality of A-MPDU sub-frames is addressed to at least a second device. The method comprises inserting an indication that the A-MPDU frame is addressed to at least the first and second devices into a physical layer convergence procedure (PLCP) protocol data unit (PPDU) field.

### CROSS REFERENCE TO RELATED APPLICATIONS

This application claims priority under 35 U.S.C. §119(e) to U.S. Provisional Patent Application No. 62/043,061 entitled “SYSTEMS AND METHODS FOR SIGNALING MULTI-DESTINATION AGGREGATED MULTI-USER MEDIA ACCESS CONTROL PROTOCOL DATA UNITS IN A WIRELESS NETWORK” filed on Aug. 28, 2014, which is hereby incorporated by reference in its entirety.

### BACKGROUND

1. Field

The present application relates generally to wireless communications, and more specifically to systems, methods, and devices for signaling aggregated multi-user media access control protocol data units (A-MPDUs) in a wireless network.

2. Background

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN).

As wireless communications continue to advance, communication schemes continue to grow more complicated, prompting the aggregation of medium access control (MAC) protocol data units (MPDUs) into a single physical layer convergence procedure (PLCP) protocol data unit (PPDU). There may be a need to more efficiently transmit messages and frames across various communication schemes.

### SUMMARY

The systems, methods, and devices of the invention each have several aspects, no single one of which is solely responsible for its desirable attributes. Without limiting the scope of this invention as expressed by the claims which follow, some features will now be discussed briefly. After considering this discussion, and particularly after reading the section entitled “Detailed Description” one will understand how the features of this invention provide advantages that include improved communications between access points and stations in a wireless network.

One aspect of the present application provides a method for wireless communication. The method comprises generating, by an apparatus, an aggregated media access control protocol data unit (A-MPDU) frame comprising a plurality of A-MPDU sub-frames, wherein at least one sub-frame of the plurality of A-MPDU sub-frames is addressed to at least a first device and at least one other sub-frame of the plurality of A-MPDU sub-frames is addressed to at least a second device. The method further comprises inserting an indication that the A-MPDU frame is addressed to at least the first and second devices into a PLCP protocol data unit (PPDU) field.

Another aspect of the present application provides an apparatus for wireless communication. The apparatus comprises a processor configured to generate an aggregated media access control protocol data unit (A-MPDU) frame comprising a plurality of A-MPDU sub-frames, wherein at least one sub-frame of the plurality of A-MPDU sub-frames is addressed to at least a first device and at least one other sub-frame of the plurality of A-MPDU sub-frames is addressed to at least a second device. The processor further configured to insert an indication that the A-MPDU frame is addressed to at least the first and second devices into a PLCP protocol data unit (PPDU) field. The apparatus further includes a transmitter configured to transmit the A-MPDU frame.

Yet another aspect of the present application provides a non-transitory computer-readable medium comprising code that, when executed, causes the apparatus to generate an aggregated media access control protocol data unit (A-MPDU) frame comprising a plurality of A-MPDU sub-frames, wherein at least one sub-frame of the plurality of A-MPDU sub-frames is addressed to at least a first device and at least one other sub-frame of the plurality of A-MPDU sub-frames is addressed to at least a second device. The medium further comprises code that, when executed, causes the apparatus to insert an indication that the A-MPDU frame is addressed to at least the first and second devices into a PLCP protocol data unit (PPDU) field.

Yet another aspect of the present application provides an apparatus for wireless communication. The apparatus comprises means for generating an aggregated media access control protocol data unit (A-MPDU) frame comprising a plurality of A-MPDU sub-frames, wherein at least one sub-frame of the plurality of A-MPDU sub-frames is addressed to at least a first device and at least one other sub-frame of the plurality of A-MPDU sub-frames is addressed to at least a second device. The apparatus further comprises means for inserting an indication that the A-MPDU frame is addressed to at least the first and second devices into a PLCP protocol data unit (PPDU) field. The apparatus further includes means for transmitting the A-MPDU frame.

### BRIEF DESCRIPTION OF THE DRAWINGS

FIG. 1 illustrates an example of a wireless communication system in which aspects of the present disclosure may be employed.

FIG. 2 illustrates various components that may be utilized in a wireless device that may be employed within the wireless communication system of FIG. 1.

FIG. 3 illustrates a physical layer data unit including an aggregated media access control protocol data unit as may be transmitted in the wireless communication system of FIG. 1.

FIG. 4A shows an exemplary structure of an aggregated MPDU (A-MPDU) frame.

FIG. 4B shows an exemplary structure of a PLCP protocol data unit (PPDU).

FIG. 5 shows an exemplary structure of a very high throughput (VHT) signal (SIG) field.

FIG. 6 shows an exemplary structure of another very high throughput (VHT) signal (SIG) field.

FIG. 7 shows an exemplary structure of a media access control (MAC) protocol data unit (MPDU) frame.

FIG. 8 shows an exemplary frame exchange between an access point and multiple stations using orthogonal frequency-division multiplexing (OFDM) and a multi-destination (MD) A-MPDU.

FIG. 9 is a timing diagram of an exemplary frame exchange for scheduling acknowledgments in response to a downlink (DL) multi-destination frame.

FIG. 10 is a flowchart of a method of wireless communication, in accordance with an implementation.

FIG. 11 is a flowchart of a method of wireless communication, in accordance with an implementation.

FIG. 12 is a flowchart of a method of wireless communication, in accordance with an implementation.

FIG. 13 is a flowchart of a method of wireless communication, in accordance with an implementation.

### DETAILED DESCRIPTION

Various aspects of the novel apparatuses and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Wireless network technologies may include various types of wireless local area networks (WLANs). A WLAN may be used to interconnect nearby devices together, employing widely used networking protocols. The various aspects described herein may apply to any communication standard, such as WiFi or, more generally, any member of the IEEE 802.11 family of wireless protocols. For example, the various aspects described herein may be used as part of the IEEE 802.11ax, 801.11ac, 802.11n, 802.11g, and/or 802.11b protocols.

In some aspects, wireless signals may be transmitted according to an 802.11 protocol using orthogonal frequency-division multiplexing (OFDM), direct-sequence spread spectrum (DSSS) communications, a combination of OFDM and DSSS communications, or other schemes. Implementations of 802.11 protocols may be used for sensors, metering, and smart grid networks. Advantageously, aspects of certain devices implementing 802.11 protocols may consume less power or provide higher communication speeds than devices implementing other wireless protocols, such as 802.11b, 802.11g, 802.11n or 802.11ac for example.

Certain of the devices described herein may further implement Multiple Input Multiple Output (MIMO) technology. This may also be implemented as part of 802.11 protocols. A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels or streams, where N_{S}≦min{N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized.

In some implementations, a WLAN includes various devices which are the components that access the wireless network. For example, there may be two types of devices: access points (“APs”) and clients (also referred to as stations, or “STAB”). In general, an AP serves as a hub or base station for the WLAN and an STA serves as a user of the WLAN. For example, an STA may be a laptop computer, a personal digital assistant (PDA), a mobile phone, etc. In an example, an STA connects to an AP via a WiFi (e.g., IEEE 802.11 protocol such as 802.11ax) compliant wireless link to obtain general connectivity to the Internet or to other wide area networks. In some implementations an STA may also be used as an AP.

An access point (“AP”) may also comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, or some other terminology.

A station “STA” may also comprise, be implemented as, or known as an access terminal (“AT”), a subscriber station, a subscriber unit, a mobile station, a remote station, a remote terminal, a user terminal, a user agent, a user device, user equipment, or some other terminology. In some implementations an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

As discussed above, certain of the devices described herein may implement 802.11 protocols. Such devices, whether used as an STA or AP or other device, may be used for smart metering or in a smart grid network. Such devices may provide sensor applications or be used in home automation. The devices may instead or in addition be used in a healthcare context, for example for personal healthcare. They may also be used for surveillance, to enable extended-range Internet connectivity (e.g. for use with hotspots), or to implement machine-to-machine communications. Aggregated MPDUs (A-MPDUs) for multiple destinations may be efficient for transferring amounts of data to several devices without incurring large overhead. Techniques are needed to indicate the presence of multi destination A-MPDUs in a PPDU and the timing of the corresponding acknowledgments.

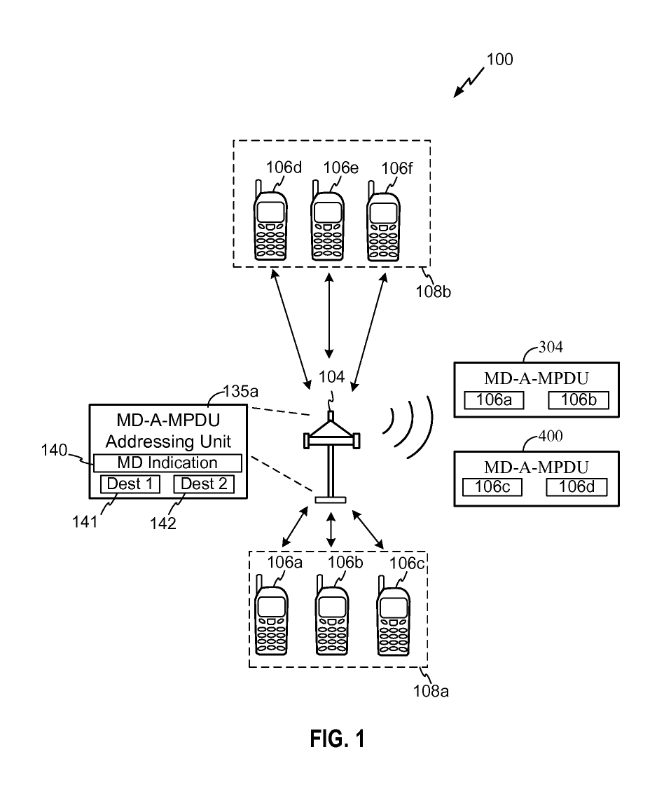

FIG. 1 illustrates an example of a wireless communication system 100 in which aspects of the present disclosure may be employed. The wireless communication system 100 may operate pursuant to a wireless standard, for example at least one of the the 802.11ac, 802.11n, 802.11g and 802.11b standards. The wireless communication system 100 may include an AP 104, which communicates with STAs 106a-106f. In some embodiments, the AP 104 may comprise a MD-A-MPDU Addressing Unit 135a. The MD-A-MPDU Addressing Unit 135a may be configured to address MPDUs of an A-MPDU frames to different stations. For example, as shown in FIG. 1, the MD-A-MPDU Addressing Unit 135a may be configured to address a first MPDU of the MD-A-MPDU frame to a first destination 141 and to address a second MPDU of the MD-A-MPDU frame to a second destination 142. The MD-A-MPDU Addressing Unit 135a may also be configured to indicate that the AP 104 is transmitting a multiple destination (MD) A-MPDU. For example, as shown in FIG. 1, the MD-A-MPDU Addressing Unit 135a may be configured to insert an MD indication 140 to indicate that AP 104 is transmitting a MD-A-MPDU frame (e.g., MD-A-MPDU 304 and MD-A-MPDU 400 described below). In some aspects, the MD indication 140 may indicate that the AP 104 is transmitting a single destination A-MPDU frame.

A variety of processes and methods may be used for transmissions in the wireless communication system 100 between the AP 104 and the STAs 106a-106f. For example, signals may be transmitted and received between the AP 104 and the STAs 106a-106f in accordance with OFDM/OFDMA techniques. If this is the case, the wireless communication system 100 may be referred to as an OFDM/OFDMA system. Alternatively, signals may be transmitted and received between the AP 104 and the STAs 106a-106f in accordance with CDMA techniques. If this is the case, the wireless communication system 100 may be referred to as a CDMA system.

In FIG. 1, the STAs 106a-106c may comprise high efficiency (HEW) wireless stations (e.g., stations that operate according to 802.11ax or later developed communication protocols), while the STAs 106d-106f may comprise “legacy” wireless stations (e.g., stations that operate according to one or more of 802.11a/b/g/n/ac communication protocols). For example, any of the STAs 106a-106c may be configured to communicate at higher data rates and/or to utilize less energy during communication or operation as compared to the legacy wireless STAs 106d-106f. Thus, for the purposes of this disclosure, the STAs 106a-106c may be considered part of a first group of STAs 108a, while the STAs 106d-106f may be considered part of a second group of STAs 108b. As illustrated, the AP 104 may transmit MD-A-MPDU frames such as frames 304 or 400 (described in further detail below) to multiple stations. For example, the AP 104 may transmit the MD-A-MPDU frame 304 to STAs 106a and 106b and may transmit the MD-A-MPDU frame 400 to STAs 106c and 106d.

It should be noted that the wireless communication system 100 may not have a central AP 104, but rather may function as a peer-to-peer network between the STAs 106a-106f. Accordingly, the functions of the AP 104 described herein may alternatively be performed by one or more of the STAs 106a-106f.

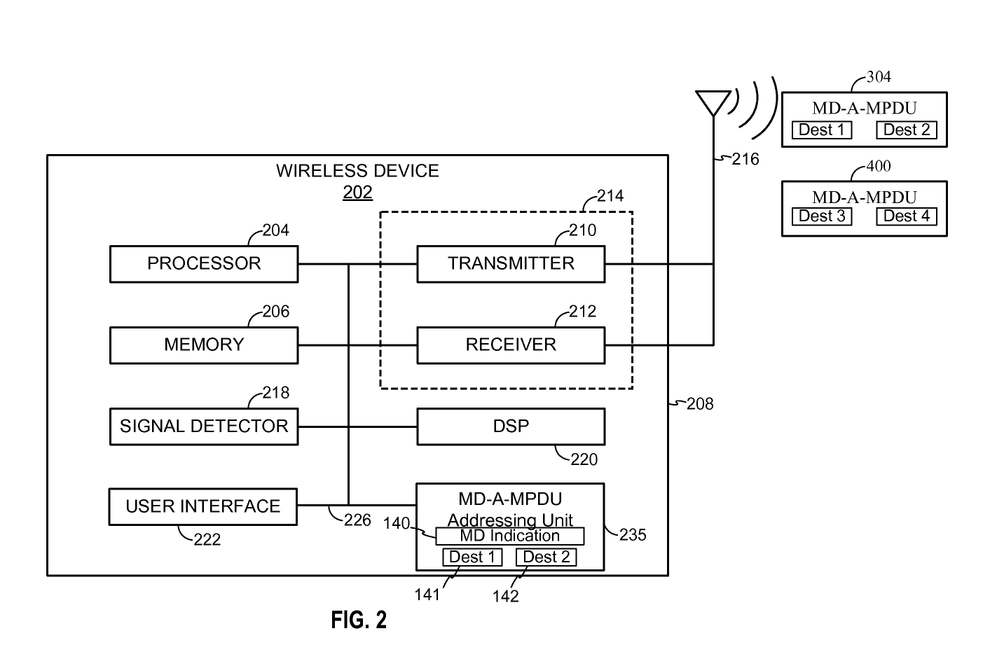

FIG. 2 illustrates various components that may be utilized in a wireless device 202 that may be employed within the wireless communication system 100. The wireless device 202 is an example of a device that may be configured to implement the various methods described herein. For example, the wireless device 202 may comprise the AP 104 or one of the STAs 106a-106f.

The wireless device 202 may include a processor 204 which controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The processor 204 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include non-transitory machine-readable media for storing code or software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas, which may be utilized during MIMO communications, for example.

The wireless device 202 may also include a signal detector 218 that may be used in an effort to detect and quantify the level of signals received by the transceiver 214. The signal detector 218 may detect such signals as total energy, energy per subcarrier per symbol, power spectral density and other signals. The wireless device 202 may also include a digital signal processor (DSP) 220 for use in processing signals. The DSP 220 may be configured to generate a data unit for transmission. In some aspects, the data unit may comprise a PPDU. In some aspects, the PPDU may be referred to as a frame or packet. In some aspects, the PPDU may comprise an aggregated MPDU comprising a plurality of MPDUs.

The wireless device 202 may further comprise a user interface 222 in some aspects. The user interface 222 may comprise a keypad, a microphone, a speaker, and/or a display. The user interface 222 may include any element or component that conveys information to a user of the wireless device 202 and/or receives input from the user.

In some aspects, the wireless device 202 may further comprise a MD-A-MPDU Addressing Unit 235. The MD-A-MPDU Addressing Unit 235 may be configured to address each MPDU of an A-MPDU frames to a different station. The MD-A-MPDU Addressing Unit 235 may also be configured to indicate that the AP 104 is transmitting a multiple destination A-MPDU. In some aspects, the MD-A-MPDU Addressing Unit 235 is similar to and performs similar functions as the MD-A-MPDU Addressing Unit 135a of FIG. 1. For example, as shown in FIG. 2, the MD-A-MPDU Addressing Unit 235 may be configured to address a first MPDU of the MD-A-MPDU frame to a first destination 141 and to address a second MPDU of the MD-A-MPDU frame to a second destination 142. Additionally, as shown in FIG. 2, the MD-A-MPDU Addressing Unit 135a may be configured to insert an MD indication 140 to indicate that AP 104 is transmitting a MD-A-MPDU frame (e.g., MD-A-MPDU 304 and MD-A-MPDU 400 described below) or transmitting a single destination A-MPDU. As illustrated, antenna 216 may be used to transmit MD-A-MPDU frames such as frames 304 or 400 (described in further detail below). MD-A-MPDU frames 304 and 400 may each contain information more two or more devices. For example, the MD-A-MPDU frame 304 may contain data for a first destination (Dest 1) and a second destination (Dest 2). Additionally, the MD-A-MPDU frame 400 may contain data for a third destination (Dest 3) and a fourth destination (Dest 4). In some aspects, the destinations (Dest 1-4) may comprise one or more of the STAs 106a-f and/or the AP 104 of FIG. 1. In some aspects, transmitting MD-A-MPDU frames can allow for efficient use of the wireless medium and reduce overhead.

The various components of the wireless device 202 may be coupled together by a bus system 226. The bus system 226 may include a data bus, for example, as well as a power bus, a control signal bus, and a status signal bus in addition to the data bus. Those of skill in the art will appreciate the components of the wireless device 202 may be coupled together or accept or provide inputs to each other using some other mechanism.

Although a number of separate components are illustrated in FIG. 2, those of skill in the art will recognize that one or more of the components may be combined or commonly implemented. For example, the processor 204 may be used to implement not only the functionality described above with respect to the processor 204, but also to implement the functionality described above with respect to the signal detector 218 and/or the DSP 220. Further, each of the components illustrated in FIG. 2 may be implemented using a plurality of separate elements.

As discussed above, the wireless device 202 may comprise an AP 104 or an STA 106a-106f, and may be used to transmit and/or receive communications. The communications exchanged between devices in a wireless network may include data units which may comprise packets or frames. In some aspects, the data units may include data frames, control frames, and/or management frames. Data frames may be used for transmitting data from an AP and/or a STA to other APs and/or STAs. Control frames may be used together with data frames for performing various operations and for reliably delivering data (e.g., acknowledging receipt of data, polling of APs, area-clearing operations, channel acquisition, carrier-sensing maintenance functions, etc.). Management frames may be used for various supervisory functions (e.g., for joining and departing from wireless networks, etc.).

An aggregate media access control protocol data unit (A-MPDU) frame allows a device to send multiple data frames in a single physical layer frame. Typically a physical layer frame (e.g., A-MPDU) is intended only for a single destination. Each physical layer frame transmission, however, requires a certain amount of overhead (e.g., preamble overhead, sounding, and channel state information feedback). In many downlink traffic situations, frames may be sent to multiple destinations. Some examples for downlink traffic sources for frames include downlink transmission control protocol (TCP) acknowledgments (e.g., in response to audio/video/data uploads, http get etc.), phone applications (e.g., receiving posts via Facebook or Twitter, ad push notifications, email notifications), and VoIP sessions. In such situations where multiple frames are sent to multiple destinations, it may be desirable to send a single A-MPDU containing frames for multiple destinations. In some aspects, this may be desirable when transmitting small frames (e.g., less than 50 bytes) where a physical layer preamble overhead may be large compared to the size of the frame. For example, for a 50 byte frame at 80 MHz transmitted with an MCS 7 as defined in the 802.11ac standard, there may be 10 OFDM symbols of preamble for 1 OFDM symbol of data. Accordingly, one non-limiting method of reducing such overhead may be to aggregate frames for multiple destinations in a single PPDU. Embodiments described herein relate to transmitting and signaling the presence of multiple destination (MD) A-MPDUs and relate to acknowledgments by stations receiving the MD-AMPDU.

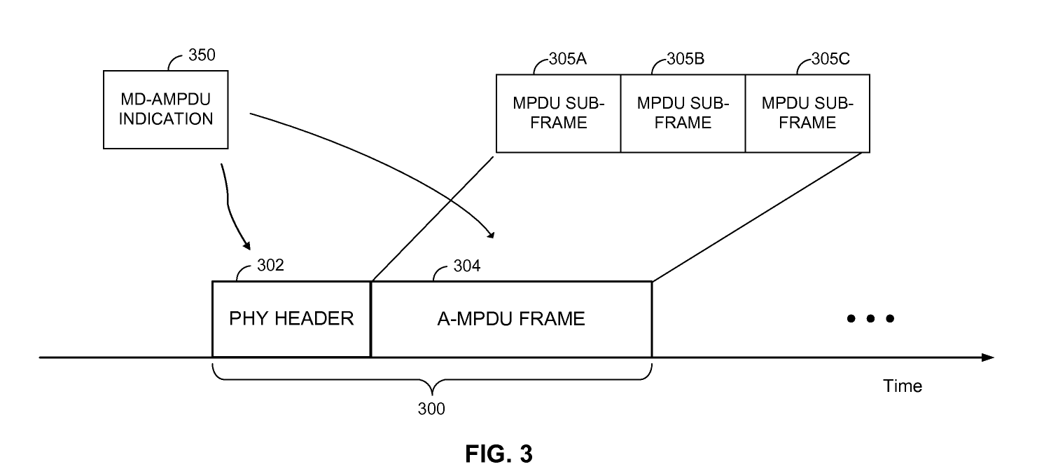

FIG. 3 illustrates a physical layer data unit 300 including a physical layer (PHY) header 302 and an aggregated media access control protocol data unit 304 as may be transmitted in the wireless communication system 100 of FIG. 1. As shown, time increases horizontally across the page on the x-axis. If the AP 104 of FIG. 1 has buffered units to send to more than one of the STAs 106a-106f, instead of transmitting multiple wireless messages, the AP 104 may transmit a single aggregated MPDU frame 304. The A-MPDU frame 304 may include multiple A-MPDU sub-frames 305A-305C. One or more of the multiple A-MPDU sub-frames 305A-305C may be addressed to a different STA than one or more of the multiple A-MPDU sub-frames 305A-305C. In some embodiments, the A-MPDU Addressing Unit 235 of FIG. 2 may be configured to address the A-MPDU sub-frames 305A-305C to each of the different STAs (e.g., STAs 106a-106f).

However, the 802.11a/b/g/n/ac wireless communication protocols prescribe that all MPDU frames in a PPDU comprising an A-MPDU are addressed to the same STA. Thus, the legacy STAs 106d-106f, operating according to one or more of the 802.11a/b/g/n/ac wireless communication protocols may discontinue processing the A-MPDU frame 304 (or transition to a power save mode) if the first MPDU sub-frame 305A is not addressed to the particular legacy STA 106d-106f receiving the PPDU 300. HEW STAs 106a-106c however, may require a particular indication that the A-MPDU frame 304 is meant for multiple destinations to properly decode the A-MPDU frame 304. In some embodiments, the indication that the A-MPDU frame 304 is meant for multiple destinations may comprise MD-AMPDU indication 350 which may be included in either the PHY header 302 portion or the A-MPDU frame 304 portion of the PPDU 300.

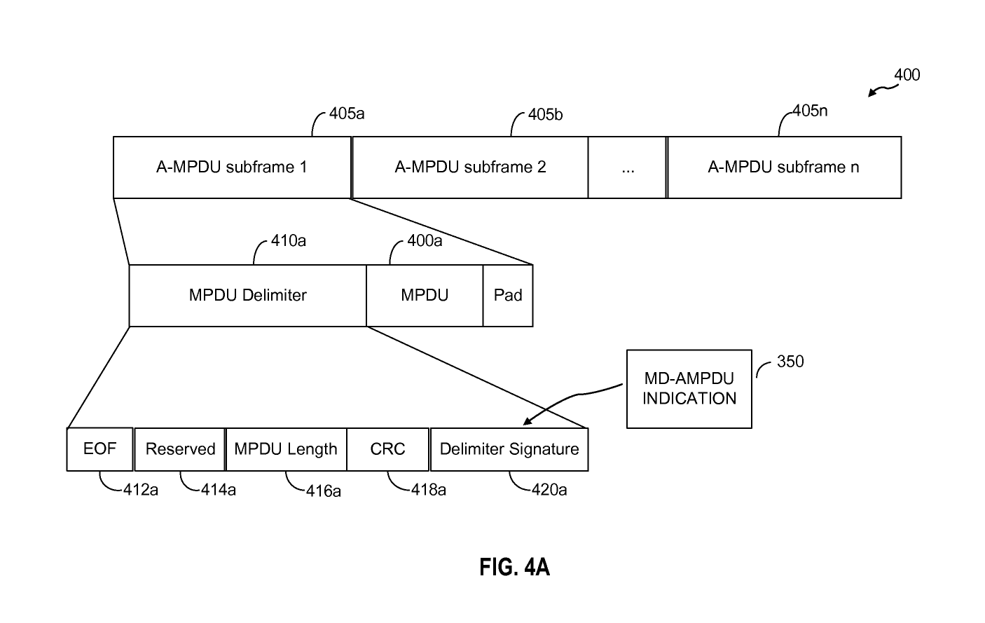

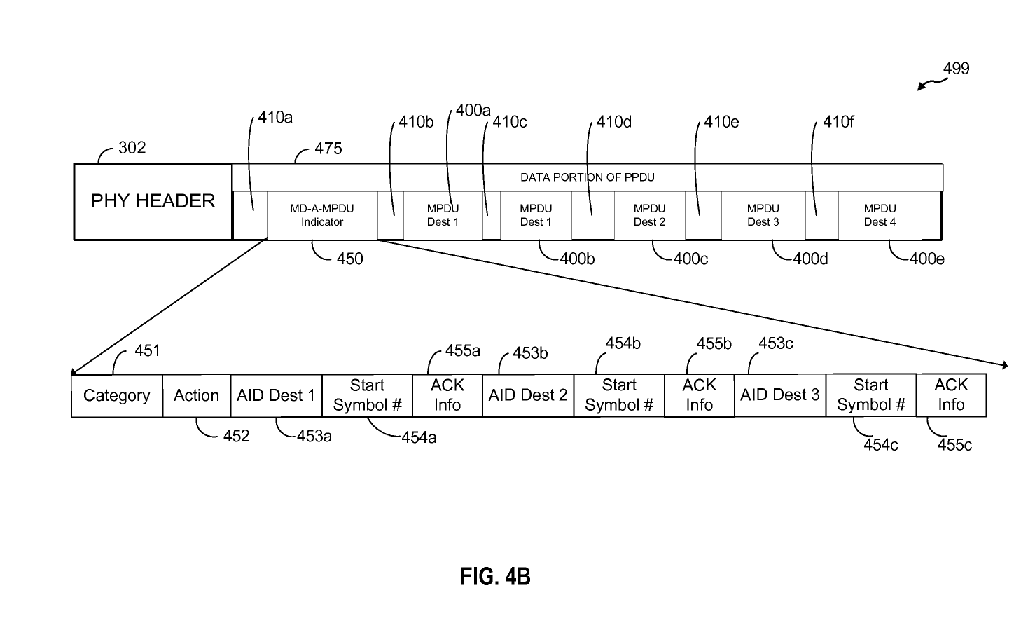

FIG. 4A shows an exemplary structure of an aggregated MPDU (A-MPDU) frame 400. As shown, the A-MPDU frame 400 includes a variable number (n) of A-MPDU sub-frames, as shown 405a, 405b, and 405n. In some embodiments each of the A-MPDU sub-frames 405a, 405b, and 405n may be intended for different stations. Each of the A-MPDU sub-frames 405a, 405b, and 405n may in some aspects be comprised of an MPDU delimiter field 410a, an MPDU frame 400a, and zero or more pad bytes. The MPDU frames 300a may in some aspects conform substantially with the MPDU frames 305a-305c illustrated in FIG. 3.

Each of the MPDU delimiter fields, for example, MPDU delimiter field 410a, may include an end of frame (EOF) field 412a, a reserved field 414a, an MPDU length field 416a, a CRC field 418a, and a delimiter signature field 420a. The delimiter signature field 420a may to indicate a difference between two MSDU subframe delimiter signature fields. Typically, this field is set to the hexidecimal value 7E.

In some embodiments, the delimiter signature field 420a may indicate to stations equipped with a protocol to decode MD-AMPDUs (e.g., HEW stations) that the A-MPDU is a MD-AMPDU. For example, in MD-AMPDU frames, the delimiter signature field 420a may comprise the MD-AMPDU indication 350 to indicate the presence of the MD-AMPDU frame 400. In some embodiments, the delimiter signature field 420a may be set a different value than 7E, such as 7D, and that different value is specified and known to all HEW stations. Legacy stations (e.g., STAs 106d-106f) that receive and decode the delimiter signature field 420a as 7D will drop the frame, whereas HEW stations (e.g., STAs 106a-106c) will decode the delimiter signature field 420a as 7D will know that the A-MPDU frame 400 is a MD-AMPDU. In some embodiments, the A-MPDU Addressing Unit 235 of FIG. 2 may be configured to address each of the A-MPDU sub-frames 405a-405n to different STAs (e.g., STAs 106a-106f).

FIG. 4B shows an exemplary structure of a MD PPDU 499. The MD PPDU frame 499 comprises the PHY header 302 and the data portion of the PPDU 475. In some embodiments, the data portion of the PPDU 475 may comprise the A-MPDU frame 304 of FIG. 3. As shown, the data portion of the PPDU 475 comprises MPDU delimiters 410a-410f, a MD-AMPDU indicator field 450 and MPDUs 400a-400e. The MD-AMPDU indicator field 450 may comprise a single management MPDU as the first MPDU which indicates that the MD PPDU 499 comprises a MD-AMPDU frame and indicates the destinations of MPDUs 400 that are included in the data portion of the PPDU 300. As shown, the MD-AMPDU indicator 450 comprises a category field 451 which indicates the category for the MD-AMPDU indicator field 450, an action field 452 to specify certain actions for the stations receiving the MD PPDU 499, an address identifier (AID) field (e.g., 453a-453c) of destination STAs, an approximate symbol start field (e.g., 454a-454c) of the destination STAs, and an acknowledgement information (ACK Info) field (e.g., 455a-455c) which includes information on how the uplink acknowledgement should be sent for the destination STAs.

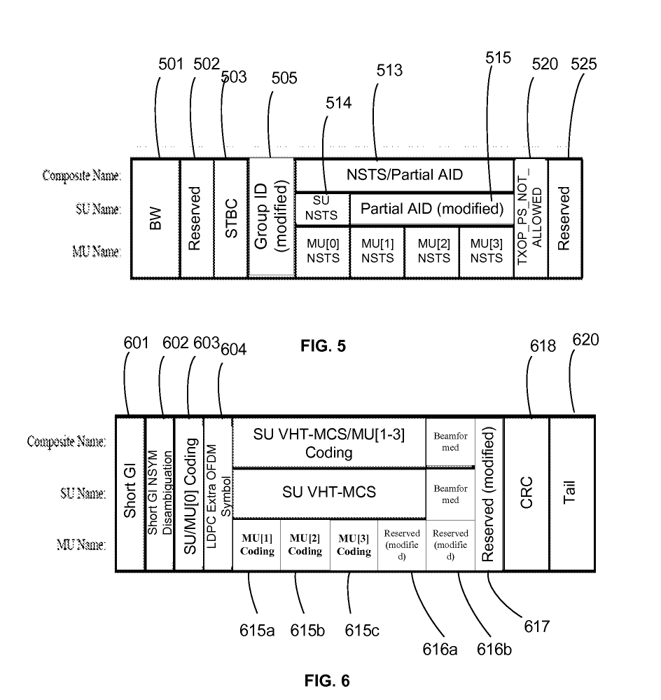

In some embodiments, a very high throughput (VHT) signal (SIG) field of a physical layer header field (e.g., PHY header 302) may indicate to stations equipped with a protocol to decode MD-AMPDUs (e.g., HEW stations) that an A-MPDU is a MD-AMPDU. FIG. 5 shows an exemplary VHT-SIG-A field 500. In some embodiments, the name of sub-fields of the VHT-SIG-A field 500 may depend on the type of transmission. For example, as shown in FIG. 5 (and similarly in FIG. 6), the name of certain subfields depends on whether the VHT-SIG-A field 500 is transmitted under a composite transmission (e.g., composite name), a single user transmission (e.g., SU name), or a multi-user transmission (e.g., MU name). The names of sub-fields for the different transmissions correspond to rows of FIG. 5 and FIG. 6 indicating the transmission type.

As shown in FIG. 5, the VHT-SIG-A field 500 comprises bandwidth field 501, a reserved field 502, a space-time block coding field 503, a group identifier field (ID) 505, a transmission opportunity power save not allowed field 520, and a second reserved field 525. Under the composite name for the VHT-SIG-A field 500, the VHT-SIG-A field 500 comprises a number of space time streams (NSTS)/partial address identifier field 513. Under a single user transmission, the VHT-SIG-A field 500 comprises single user NSTS field 514 and a partial address identifier (AID) field 515. In some embodiments, the AP 104 may determine and communicate to stations associated with the AP 104 that a certain partial AID value is reserved to indicate that an A-MPDU with that particular partial AID is a MD-AMPDU. The partial AID field 515 may be modified to indicate the presence of a MD-AMPDU. In some aspects, the MD-A-MPDU Addressing Unit 135a of FIG. 1 may be configured to indicate that an A-MPDU with that particular partial AID is a MD-AMPDU. Stations not associated with the AP 104 may read and drop the MD-AMPDU because the partial AID field 515 does not match their AID or partial AID. In some embodiments, the partial AID field 515 may comprise 9 bits.

The group ID field 505 may identify a group of stations that should receive the A-MPDU. In some embodiments, the group ID field 505 may be configured or modified to indicate the presence of a MD-AMPDU frame. For example, the AP 104 may determine and communicate that a certain group ID, or a set of group IDs, is reserved to indicate to receiving stations that the frame is a MD-AMPDU frame. In some embodiments, the reserved group ID may be in the range of 01 to 62. In some aspects, the use of a group ID to indicate the presence of a MD-AMPDU frame can help some devices to shutoff receiver circuitry when the A-MPDU does not contain MPDUs for them. In some aspects, the MD-A-MPDU Addressing Unit 135a of FIG. 1 may be configured to indicate that an A-MPDU with a particular group ID value is a MD-AMPDU. In some embodiments, the group ID field may comprise 6 bits.

In other embodiments, a reserved bit of the VHT-SIG-A field may indicate that a A-MPDU is a MD-AMPDU. FIG. 6 is a diagram of an exemplary VHT-SIG-A2 field 600 structure. The VHT-SIG-A2 field 600 comprises a short guard interval (GI) field 601, a short GI number of transmission symbols (NSYM) disambiguation field 602, a single/multi-user (SU/MU) coding field 603, a low-density parity check (LDPC) extra OFDM symbol field 604, a reserve field 617, a cyclic redundancy check (CRC) field 618, and a tail field 620. Under multiple user transmissions, the VHT-SIG-A2 field 600 comprises MU coding fields 615a, 615b, 615c and reserve bits 616a and 616b. Typically, if a bit is marked reserved, the bit is set to zero. In some embodiments, in order to indicate the presence of a MD-AMPDU frame, one or more of the reserved bits may modified and/or set to 1. In these embodiments, legacy stations (e.g., stations (e.g., STAs 106d-106f) that receive and decode the VHT-SIG-A2 field 600 with one or more of the reserve bits 616a, 616b and 617 set to 1 will be unable to decode the frame and will drop the rest of the frame. HEW stations (e.g., STAs 106a-106c) will be equipped with the protocol to know which reserve bits indicate the presence of the MD-A-MPDU frame and will decode the remainder of the frame. In some aspects, the MD-A-MPDU Addressing Unit 135a of FIG. 1 may be configured to indicate that an A-MPDU with one or more of the reserved bits 616a, 616b and 617 set to 1 is a MD-AMPDU.

In some embodiments, a SIG field with a different frame format than those shown in FIGS. 5 and 6 may be used. This SIG field may be used for all MD-A-MPDUs and may be decodable only by HEW stations. In some aspects, the same indications described above may be applied to PPDUs using this SIG field with a different frame format. Additionally, the indication that the A-MPDU frame (e.g., A-MPDU 304 or 400) is meant for multiple destinations may be located in any other preamble field (e.g., a signal (SIG) field, long training field (LTF), short training field (STF), etc.). In some aspects, the preamble field may be located within the PHY header portion 302.

In some embodiments, the AP 104 may set an acknowledgment policy for stations receiving MD-AMPDUs (e.g., A-MPDU 400). To coordinate acknowledgements from each of the STAs, one or more of the A-MPDU sub-frames 305a-305c or 405a-405n (See FIGS. 3 and 4) may include one or more fields defining an acknowledgement policy (e.g., transmission parameters of acknowledgment frames transmitted from each of the STAs in response to the A-MPDU 400) for the A-MPDU sub-frame. For example, the acknowledgement policy may indicate whether an acknowledgement for the A-MPDU sub-frame should be transmitted by an addressed receiver, the type of acknowledgement that should be transmitted (e.g., whether an acknowledgement or block acknowledgement should be transmitted) and/or a delay time period between when the A-MPDU frame 304 is received and when an acknowledgement to any MPDU sub-frame included in the A-MPDU frame 304 is transmitted. The indicated acknowledgement policy of each A-MPDU sub-frame 305a-c, 405a-405n functions to coordinate acknowledgements of each of the MPDU sub-frames 305a-305c, 405a-405n so as to reduce the probability of collisions occurring if each of the MPDU sub-frames 305a-305c, 405a-405n is acknowledged.

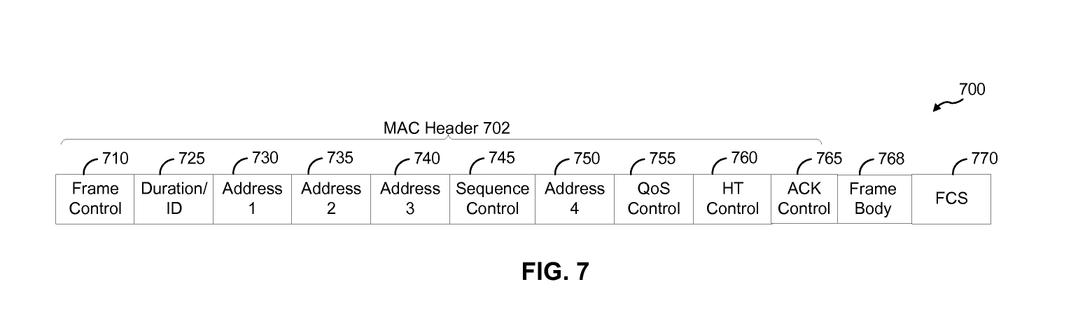

In order to set the acknowledgment, the AP 104 may include an indication of the acknowledgment policy in the MAC header portion of a frame. FIG. 7 shows an exemplary structure of a media access control protocol data unit (MPDU) frame 700. The MPDU frame 700 may correspond to any of the MPDU sub-frames 305A-305C or 405A-406N, as previously described in connection with FIGS. 3 and 4, respectively. As shown, the MPDU frame 700 includes 12 different fields: a frame control (fc) field 710, a duration/identification (dur) field 725, a receiver address (a1) field 730, a transmitter address (a2) field 735, a destination address (a3) field 740, a sequence control (sc) field 745, a fourth address (a4) field 750, a quality of service (QoS) control (qc) field 755, a High Throughput (HT)/VHT control field 760, an acknowledgment (ACK) control field 765, a frame body 768, and a frame check sequence (FCS) field 770. Some or all of the fields 710-765 make up the MAC header 702.

The ACK control field 765 may indicate to a station receiving the MPDU frame 700 when and how a BA is sent and a time gap (or frequency offset or spatial stream gap) between successive BAs (e.g., transmission parameters of block acknowledgment frames transmitted from each of the STAs in response to the MPDU frame 700). For example, ACK control field 765 may indicate that one or more stations should send a BA a Short Interframe Space (SIFS) time period after the PPDU carrying the MPDU frame 700. In some embodiments, the presence of the ACK control field 765 may be indicated using a reserved bit/bit combination in the frame control field 710, QoS control field 755 or the HT/VHT control field 760. Information that may be included in the ACK control field 765 may include: BA modulation and coding scheme (MCS); bandwidth and/or spatial stream information such as total uplink bandwidth, per STA bandwidth for BA, or the total number of uplink spatial streams; and BA index in which each STA determines the time, exact bandwidth and spatial stream index from its BA index and the bandwidth and spatial stream information.

In some embodiments, any two octet field may be sufficient to create the ACK control field 765. In some embodiments, ten (10) bits of the ACK control field 765 may be partitioned as follows: 3 bits to indicate a number of spatial streams (e.g, one of 8 spatial stream indices), 4 bits to indicate a number of frequency bands (e.g., one of 16 frequency bands), and 3 bits to indicate a time position for the BA. From the 10 bits of the ACK control field 765, a device can determine exactly how and when to send the BA. In some embodiments, the BA MCS is to be set to MCS of the downlink PPDU.

In some embodiments, OFDMA and MD-AMPDU can be combined to optimize the time taken for the entire PPDU transmission. OFDMA allows different data rates per STA because with OFDMA, each STA is not restricted to the minimum MCS across all STAs. In some embodiments, STAs located further away from the AP 104 may have lower a MCS than STAs located closer to the AP 104. In some embodiments, STAs having higher MCSs can be combined using MD-AMPDU and this further combined with OFDMA, to transmit the higher MCSs on a specific frequency bandwidth. In some embodiments, the STAs with lower MCSs can be combined using MD-AMPDU and transmitted on a different bandwidth using OFDMA to attain an overall lower length PPDU to be transmitted and increase the data rate of the system.

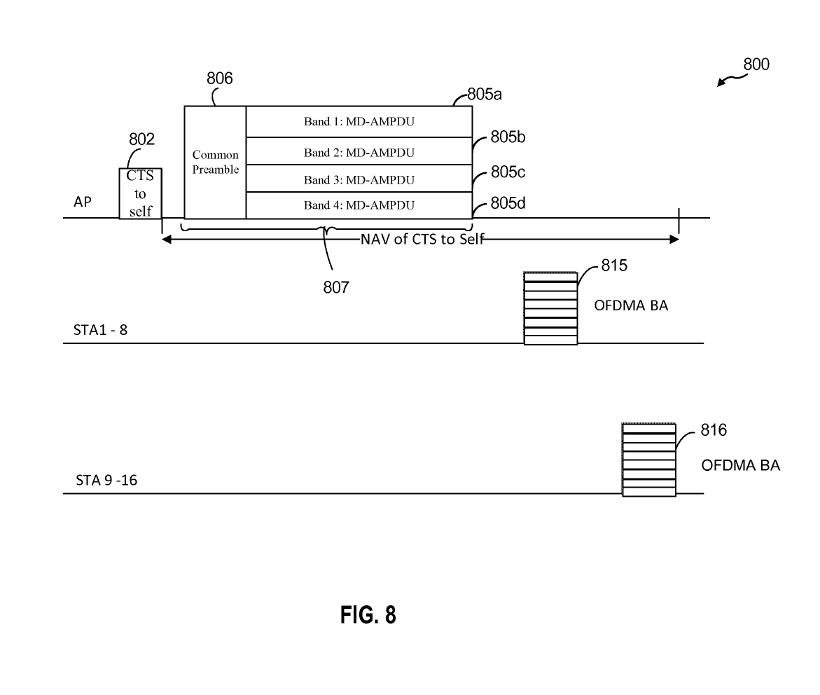

FIG. 8 is a timing diagram of an exemplary frame exchange using OFDMA and MD-AMPDU. In FIG. 8, the AP 104 sends a clear to send (CTS) to self message 802 to reserve the medium for the MD-AMPDU transmission and the corresponding uplink acknowledgments from the STAs receiving the MD-AMPDU. The AP 104 next transmits a PPDU 807 which comprises a common preamble portion 806 and MD-AMPDU messages 805a-d. In some embodiments, the MD-AMPDU message 805a transmitted over a first bandwidth may comprise the MD-AMPDU frames 304, 400, and 475 of FIGS. 3, 4A and 4B. In some embodiments, the common preamble portion 806 may comprise the PHY header portion 302 of FIG. 3. Additionally each MD-AMPDU 805a-d is transmitted over a different frequency bandwidth. In some embodiments, the MD-AMPDU message 805a may be addressed to STAs having a higher MCS than the STAs addressed in the MD-AMPDU messages 805b-805d

The MD-AMPDUs 805a-d may also include an indication of which STAs should send an acknowledgment and at what time, as discussed above. For example, the MD-AMPDU messages 805a and 805b may be addressed to STAs 1-8 and may have an indication in a MAC header of a MDPU that indicates that the STAs 1-8 should send their ACK messages over different frequencies a SIFS time after receiving the MD-AMPDU messages 805a and 805b. The MD-AMPDU messages 805c and 805d may be addressed to STAs 9-16 and may have an indication in a MAC header of a MDPU that indicates that the STAs 9-16 should send their ACK messages over different frequencies a specific time after receiving the MD-AMPDU messages 805c and 805d. The specific time may be determined by the AP 104 by calculating the transmission time for the PPDU 810 based on the MCS of the STAs and based on the estimated transmission time of the ACK messages from STAs 1-8. As shown, 8 STAs (e.g., STAs 1-8) send uplink BAs 815 over 8 different bandwidths a short time (e.g., SIFS) after receiving MD-AMPDUs 805a-d. A short time after the uplink BAs 815, 8 more STAs (e.g., STAs 9-16) send uplink BAs 816 over 8 different bandwidths to the AP 104.

This combination of OFDMA and MD-AMPDU may require that the AP 104 indicate to each station the particular frequency band and the particular MCS for the combined OFDMA and MD-AMPDU transmission. Accordingly, AP 104 may indicate one or more groups of STAs to participate in the combined OFDMA and MD-AMPDU transmission and may indicate the particular frequency bandwidth for each group. In some embodiments, the indication of how the bandwidth is allocated may comprise two bits. For example, if both bits are set to zero, then the bandwidth is not divided and 8 stations may share that frequency bandwidth. If the bits are set to “01” the bandwidth may be divided into two different frequency bandwidths and 4 stations may be assigned to each bandwidth. In some embodiments, if the bits are set to “10” then the frequency may be split into 4 different bandwidths with 2 STAs assigned to each bandwidth. In some embodiments, if the bits are set to “11” then the frequency may be split into 8 different bandwidths with a single STA assigned to each bandwidth.

In some embodiments, a six bit group identifier (ID) is used to indicate a particular bandwidth for a STA in the PPDU according to the bandwidth allocation. In these embodiments, in each group ID a STA is assigned a position in the bandwidth according to the highest bandwidth division. In embodiments that have fewer frequency bandwidth divisions, the STA position may be determined according to its position in the highest bandwidth division For example, if a STA is allocated a position in the third bandwidth of the eight bandwidths, then if the bandwidth is divided into 4 different bandwidths, it would allocated a position in the second bandwidth position. If the bandwidth is divided into 2 different bandwidths, the STA would be allocated a position in the first bandwidth group.

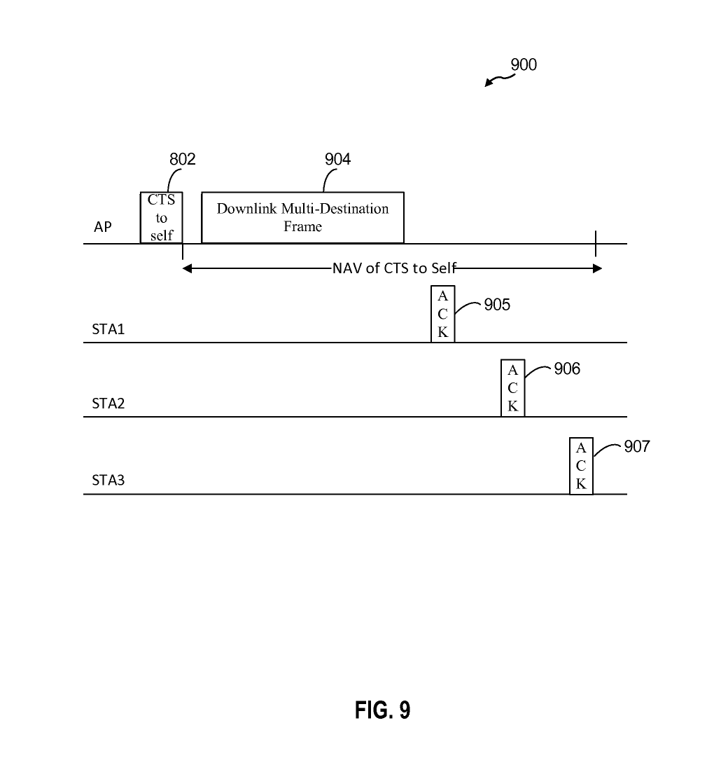

FIG. 9 is a timing diagram of an exemplary frame exchange 900 for scheduling acknowledgments in response to a downlink (DL) MD frame. As shown, the AP 104 sends a CTS to self message 802 which reserves the medium for the transmission of the downlink frame and the subsequent acknowledgment frames. The AP 104 then transmits the DL MD frame 904 to the STAs 1-3. The DL MD frame 904 may comprise a MD-AMPDU. In some embodiments, the DL MD frame 904 comprises the ACK control field 765 or other indication of the ACK policy. Using the information in the ACK control field 765 (e.g., BA MCS, total uplink bandwidth, per STA bandwidth, total uplink spatial streams, BA index, etc.) the STAs 1-3 can determine when to send ACK messages 905, 906, and 907 so that they don't interfere with each other and fit within the time reserved by the network allocation vector (NAV) of the CTS to self 802. In some aspects, one or more of the ACK messages 905, 906, and 907 may comprise a block acknowledgement (BA) message.

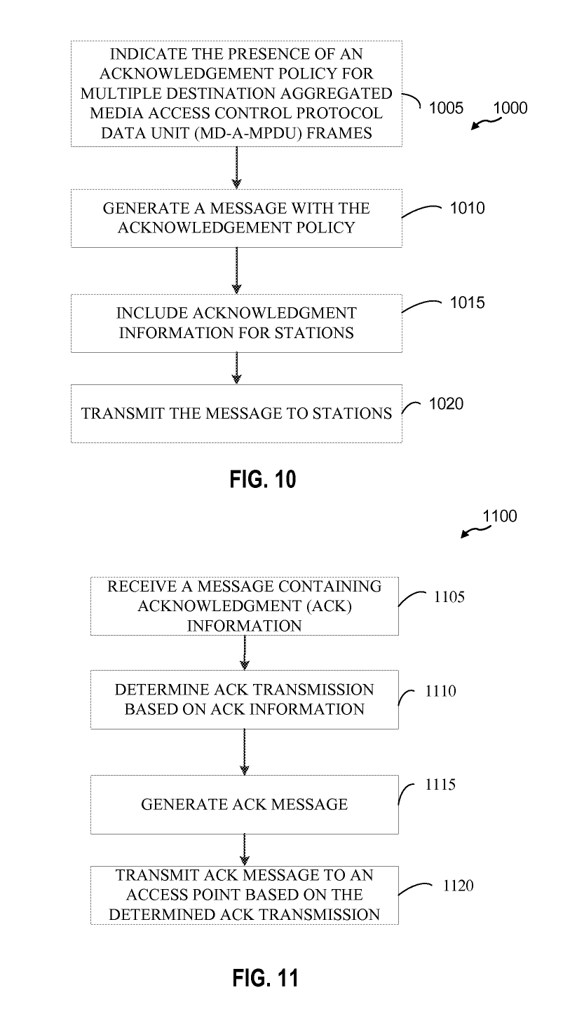

FIG. 10 is a flowchart of a method 1000 for wireless communication, in accordance with an implementation. In some aspects, the method 1000 may be performed by the wireless device 202, shown above with respect to FIG. 2. In some aspects, method 1000 may be performed by the AP 104 or any suitable device. At block 1005, the AP 104 indicates the presence of an acknowledgment (ACK) policy for responding to MD-AMPDU frames. In some embodiments, AP 104 may include this indication in the ACK control field 765. In some embodiments, the indication may be included in a portion of the FC field 710, QoS control field 755, or the HT control field 760. In some aspects, the indication may be included in the MD-AMPDU indicator 450. At block 1010, the AP 104 may generate a message with the ACK policy for responding to the MD-AMPDU. In some embodiments, the message may comprise the PPDU 300 which may comprise the A-MPDU frame 304 and MPDU 700.

At block 1015, the AP 104 may include ACK information for each of the STAs receiving the MD-AMPDU. In some embodiments, the ACK information may comprise BA MCS, total uplink bandwidth, per STA bandwidth, total uplink spatial streams, BA index, or any other information facilitate the STA determining when and how to send its ACK to the AP 104. At block 1020, the AP 104 may then transmit the message to the different STAs.

FIG. 11 is a flowchart of a method 1100 for wireless communication, in accordance with an implementation. In some aspects, the method 1100 may be performed by the wireless device 202, shown above with respect to FIG. 2. In some aspects, method 1100 may be performed by the STA 106a or any suitable device. At block 1105, the STA 106a may receive a message containing ACK information. In some embodiments, the message may comprise a MD-AMPDU frame from the AP 104 which comprises the ACK control field 765. At block 1110, the STA 106a may then determine when and how to send its ACK message transmission based on the ACK information. For example, the ACK control field 765 may include a MCS, a bandwidth allocated to the STA 106a, and an order of when the STA should send its ACK message. The STA 106a may then determine based on such information the specific time to transmit the ACK and type of transmission (e.g., BA, MU-MIMO, FDMA, OFDMA, etc.). At block 1115, the STA 106a may then generate the ACK message. In some embodiments, the ACK message is generated based on the determination in block 1110. At block 1120, the STA 106a transmits to the ACK message to the AP 104 based on the determined transmission.

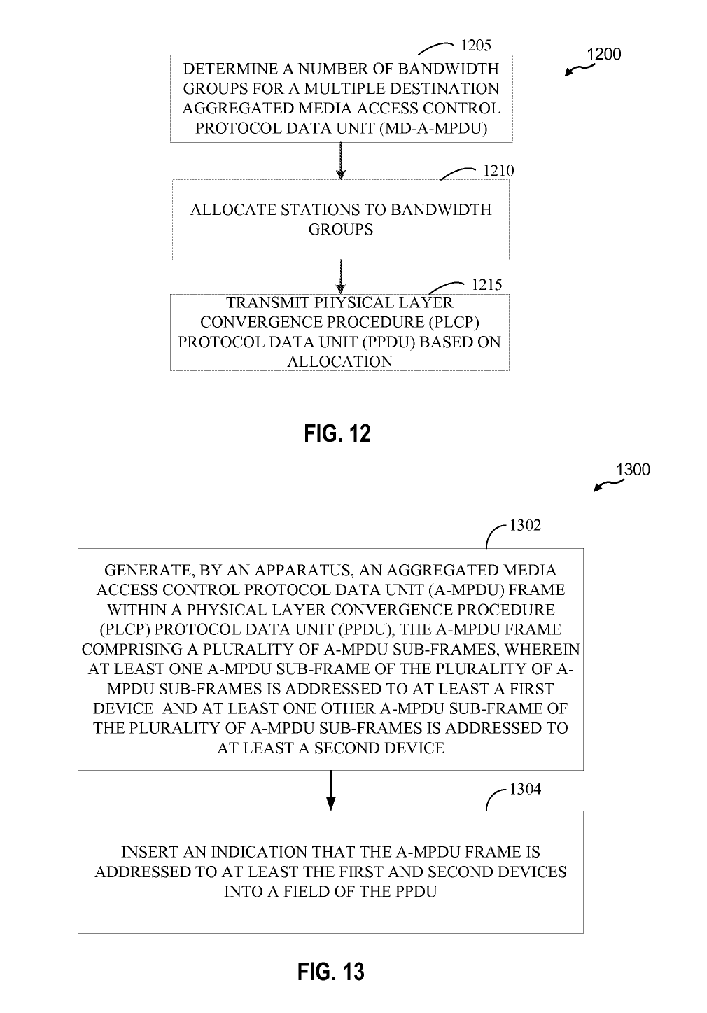

FIG. 12 is a flowchart of a method 1200 for wireless communication, in accordance with an implementation. In some aspects, the method 1200 may be performed by the wireless device 202, shown above with respect to FIG. 2. In some aspects, method 1200 may be performed by the AP 104 or any suitable device. At block 1205, the AP 104 may determine a number of bandwidth groups for a MD-AMPDU message. For example, with reference to FIG. 8, the AP 104 determines that the bandwidth for the PPDU 807 transmission should be divided into 4 different bandwidths. At block 1210, the AP 104 then allocates STA to each bandwidth group. As discussed above with reference to FIG. 8, in some embodiments, the AP 104 may allocate STAs 1-8 to bandwidth groups 1 and 2 (e.g., MD-AMPDU messages 805a-b) and may allocate STAs 9-16 to bandwidth groups 3 and 4 (e.g., MD-AMPDU messages 805c-d). At block 1215, the AP 104 may then transmit the PPDU based on the bandwidth allocation. For example, the AP 104 may transmit PPDU 807 of FIG. 8 based on the bandwidth allocation of the 4 different bandwidths shown.

FIG. 13 is a flowchart of a method 1300 of wireless communication, in accordance with an implementation. In some aspects, the method 1300 may be performed by the wireless device 202, shown above with respect to FIG. 2. In some aspects, method 1300 may be performed by the AP 104. The method 1300 may correspond to one or more implementations, as previously described in connection with FIGS. 3-9.

Block 1302 includes generating, by an apparatus, an aggregated media access control protocol data unit (A-MPDU) frame within a PLCP protocol data unit (PPDU), the A-MPDU frame comprising a plurality of A-MPDU sub-frames, wherein at least one A-MPDU sub-frame of the plurality of A-MPDU sub-frames is addressed to at least a first device and at least one other A-MPDU sub-frame of the plurality of A-MPDU sub-frames is addressed to at least a second device. For example, as previously described in connection with FIG. 4, the A-MPDU 400 comprises a plurality of A-MPDU sub-frames 405a-405n. As previously described, the plurality of A-MPDU sub-frames are intended for one or more devices. In one aspect, the A-MPDU 405a may be addressed to a first device (e.g., STA 106a of FIG. 1) and the A-MPDU 405b may be addressed to a second device (e.g., STA 106d of FIG. 1).

Block 1304 includes inserting an indication that the A-MPDU frame is addressed to at least the first and second devices into a field of the PPDU. For example, as previously described in connection with FIG. 4, a value may be inserted into the delimiter signature field 420a of the media access control protocol data unit (MPDU) delimiter field 410a of at least a first A-MPDU sub-frame 405a, to indicate that the A-MPDU 405a is intended for the legacy STA 106a. In some implementations of FIG. 5, a value may be inserted into the partial AID field 515 to indicate that the A-MPDU frame that follows (e.g., the A-MPDU frame 304 of FIG. 3) is a multi-destination A-MPDU with the MPDU 305a addressed to a first device (e.g., STA 106a of FIG. 1) and the MPDU 305b addressed to a second device (e.g., STA 106d of FIG. 1). In some embodiments, the delimiter signature field 420a may comprise 8 bits.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. Further, a “channel width” as used herein may encompass or may also be referred to as a bandwidth in certain aspects.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

As used herein, the term interface may refer to hardware or software configured to connect two or more devices together. For example, an interface may be a part of a processor or a bus and may be configured to allow communication of information or data between the devices. The interface may be integrated into a chip or other device. For example, in some embodiments, an interface may comprise a receiver configured to receive information or communications from a device at another device. The interface (e.g., of a processor or a bus) may receive information or data processed by a front end or another device or may process information received. In some embodiments, an interface may comprise a transmitter configured to transmit or communicate information or data to another device. Thus, the interface may transmit information or data or may prepare information or data for outputting for transmission (e.g., via a bus).

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and Blu-ray® disc where disks usually reproduce data magnetically, while discs reproduce data optically with lasers. Thus, in some aspects, computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A method of wireless communication, comprising:
generating, by an apparatus, an aggregated media access control protocol data unit (A-MPDU) frame within a physical layer convergence procedure (PLCP) protocol data unit (PPDU), the A-MPDU frame comprising a plurality of A-MPDU sub-frames, wherein at least one A-MPDU sub-frame of the plurality of A-MPDU sub-frames is addressed to at least a first device and at least one other A-MPDU sub-frame of the plurality of A-MPDU sub-frames is addressed to at least a second device; and
inserting an indication that the A-MPDU frame is addressed to at least the first and second devices into a field of the PPDU.

2. The method of claim 1, wherein the at least one A-MPDU sub-frame comprises a media access control protocol data unit (MPDU) delimiter field, wherein the indication comprises a value in the MPDU delimiter field.

3. The method of claim 2, wherein MPDU delimiter field comprises a delimiter signature field, wherein the indication comprises a value in the delimiter signature field.

4. The method of claim 1, wherein the PPDU comprises a physical layer header field, wherein the indication is a value in the physical layer header field.

5. The method of claim 4, wherein the physical layer header field comprises a very high throughput (VHT) signal (SIG) field, wherein the indication is a value in the VHT-SIG field.

6. The method of claim 5, wherein the VHT-SIG field comprises a partial address identifier (AID) field, wherein the indication comprises a value in the partial AID field.

7. The method of claim 5, wherein the VHT-SIG field comprises a group identifier field, wherein the indication comprises a value in the group identifier field.

8. The method of claim 5, wherein the VHT-SIG field comprises a reserve field, wherein the indication comprises a value in the reserve field.

9. The method of claim 1, wherein the at least one A-MPDU sub-frame comprises a media access control (MAC) header, the MAC header comprising an acknowledgement control field.

10. The method of claim 9, wherein the acknowledgement control field comprises ten bits for indicating a number of spatial streams allocated, a number of frequency bands, or a time position for acknowledgment frames.

11. The method of claim 9, wherein the acknowledgement control field indicates an acknowledgment modulation and coding scheme (MCS).

12. The method of claim 9, wherein the acknowledgement control field indicates a bandwidth allocated to the first device and second device for sending an acknowledgment message in response to the A-MPDU frame.

13. The method of claim 9, further comprising inserting an indication of the acknowledgement control field into one or more of a frame control field, a very high throughput (VHT) control field, or a quality of service (QoS) control field.

14. An apparatus for wireless communication, comprising:
a processor configured to:
generate an aggregated media access control protocol data unit (A-MPDU) frame within a physical layer convergence procedure (PLCP) protocol data unit (PPDU), the A-MPDU frame comprising a plurality of A-MPDU sub-frames, wherein at least one A-MPDU sub-frame of the plurality of A-MPDU sub-frames is addressed to at least a first device and at least one other A-MPDU sub-frame of the plurality of A-MPDU sub-frames is addressed to at least a second device;
insert an indication that the A-MPDU frame is addressed to at least the first and second devices into a field of the PPDU; and
a transmitter configured to transmit the A-MPDU frame.

15. The apparatus of claim 14, wherein the at least one A-MPDU sub-frame comprises a media access control protocol data unit (MPDU) delimiter field, wherein the indication comprises a value in the MPDU delimiter field.

16. The apparatus of claim 15, wherein MPDU delimiter field comprises a delimiter signature field, wherein the indication comprises a value in the delimiter signature field.

17. The apparatus of claim 14, wherein the PPDU comprises a physical layer header field, wherein the indication is a value in the physical layer header field.

18. The apparatus of claim 17, wherein the physical layer header field comprises a very high throughput (VHT) signal (SIG) field, wherein the indication is a value in the VHT-SIG field.

19. The apparatus of claim 18, wherein the VHT-SIG field comprises one or more of a group identifier field, a partial address identifier (AID) field, and a reserve field, wherein the indication comprises a value in the group identifier field, the partial address identifier (AID) field, or the reserve field.

20. The apparatus of claim 14, wherein the at least one A-MPDU sub-frame comprises a media access control (MAC) header, the MAC header comprising an acknowledgement control field.

21. The apparatus of claim 20, wherein the acknowledgement control field comprises ten bits for indicating a number of spatial streams allocated, a number of frequency bands, or a time position for acknowledgment frames.

22. The apparatus of claim 20, wherein the acknowledgement control field indicates an acknowledgment modulation and coding scheme (MCS).

23. The apparatus of claim 20, wherein the acknowledgement control field indicates a bandwidth allocated to the first device and second device for sending an acknowledgment message in response to the A-MPDU frame.

24. A non-transitory computer-readable medium comprising code that, when executed, causes an apparatus to:
generate an aggregated media access control protocol data unit (A-MPDU) frame within a physical layer convergence procedure (PLCP) protocol data unit (PPDU), the A-MPDU frame comprising a plurality of A-MPDU sub-frames, wherein at least one A-MPDU sub-frame of the plurality of A-MPDU sub-frames is addressed to at least a first device and at least one other A-MPDU sub-frame of the plurality of A-MPDU sub-frames is addressed to at least a second device; and
insert an indication that the A-MPDU frame is addressed to at least the first and second devices into a field of the PDDU.

25. The non-transitory computer-readable medium of claim 24, wherein the A-MPDU sub-frame comprises a media access control protocol data unit (MPDU) delimiter field, wherein MPDU delimiter field includes a delimiter signature field, wherein the indication comprises a value in the delimiter signature field.

26. The non-transitory computer-readable medium of claim 24, wherein the PPDU comprises a physical layer header field, the physical layer header field including a very high throughput (VHT) signal (SIG) field, and wherein the indication is a value in the VHT-SIG field.

27. The non-transitory computer-readable medium of claim 26, wherein the VHT-SIG field comprises one or more of a group identifier field, a partial address identifier (AID) field, and a reserve field, wherein the indication comprises a value in the group identifier field, the partial address identifier (AID) field, or the reserve field.

28. The non-transitory computer-readable medium of claim 24, wherein the at least one A-MPDU sub-frame comprises a media access control (MAC) header, the MAC header comprising an acknowledgement control field for indicating an acknowledgment modulation and coding scheme (MCS).

29. An apparatus for wireless communication, comprising:
means for generating an aggregated media access control protocol data unit (A-MPDU) frame within a physical layer convergence procedure (PLCP) protocol data unit (PPDU), the A-MPDU frame comprising a plurality of A-MPDU sub-frames, wherein at least one A-MPDU sub-frame of the plurality of A-MPDU sub-frames is addressed to at least a first device and at least one other A-MPDU sub-frame of the plurality of A-MPDU sub-frames is addressed to at least a second device;
means for inserting an indication that the A-MPDU frame is addressed to at least the first and second devices into a field of the PDDU; and
means for transmitting the A-MPDU frame.

30. The apparatus of claim 29, wherein the at least one A-MPDU sub-frame comprises a media access control (MAC) header, the MAC header comprising an acknowledgement control field for indicating a bandwidth allocated to the first device and second device for sending an acknowledgment message in response to the A-MPDU frame.

31. An apparatus for wireless communication, comprising:
a processor configured to generate an aggregated media access control protocol data unit (A-MPDU) frame comprising a plurality of A-MPDU sub-frames, wherein at least one A-MPDU sub-frame of the plurality of A-MPDU sub-frames is addressed to at least a first device and at least one other A-MPDU sub-frame of the plurality of A-MPDU sub-frames is addressed to at least a second device, wherein the A-MPDU frame comprises an acknowledgement control field for indicating transmission parameters of acknowledgment frames transmitted from the first device and the second device in response to the A-MPDU frame; and
a transmitter configured to transmit the A-MPDU frame.
